(19) United States
(12) Patent Application Publication
(10) Pub. No.: US 2011/0181615 A1
(43) Pub. Date: Jul. 28, 2011

(54) METHOD FOR BINDING AN IRREGULAR MAP TO A KNOWN COORDINATE SYSTEM USING REFERENCE POINTS

(75) Inventor: Matti Saarinen, Espoo (FI)

(73) Assignee: WHATAMAP.COM OY, Espoo (FI)

(21) Appl. No.: 12/599,932

(22) PCT Filed: May 13, 2008
(86) PCT No.: PCT/FI08/50268

§ 371 Date: Jan. 13, 2010

(30) Foreign Application Priority Data
May 14, 2007 (FI) 20070373

(51) Int. Cl. G09G 5/00

(52) U.S. Cl. 345/619

(57) ABSTRACT

The present invention describes a method for locating a user on an irregular map, such as for example on an outdoor map, slope map of a downhill skiing centre or other map having an irregular scale. In the method, points on the irregular map are bound as reference points by determining the actual location of the points. Then the location of the user on the map can be calculated on the base of the actual coordinates of the user's location by utilizing the reference points.

### FIELD OF THE INVENTION

The invention relates to the production of map and navigation services using an irregular map.

### BACKGROUND OF THE INVENTION

In this patent application, the term ‘known coordinate system’ refers to a coordinate system to which it is useful or otherwise desirable to bind maps in view of the intended use of the map. However, the known coordinate system does not need to be generally known, but it is sufficient that the one who has prepared the map or who owns the map knows or could know the coordinate system.

Today, most maps are bound to a known coordinate system. The most often used known coordinate systems include for example the WGS84 coordinate system used in the GPS system, or, in Finland, the KKJ coordinate system.

However, not all maps are bound to a known coordinate system: such maps include for example many guide maps, outdoor maps or even maps and driving instructions drawn by individual persons, and so forth. A common characteristic in these and other maps is also the irregularity and actual incorrectness of the scale, which makes it very difficult to bind them to a known coordinate system. In this case for example a person carrying a GPS receiver and thereby knowing his or her location in the WGS84 coordinate system does not, however, know his or her location on that particular map.

Sometimes it may also be the case that the map is bound to a known coordinate system but the owner of the map does not know the binding. For example, the topographic paper maps prepared by land surveys of different countries are always bound to a known coordinate system, but this binding is not necessarily indicated accurately enough on the map, or, even if it was, the owner of the map might not understand or know the binding to the extent of being able to take advantage of it.

For example, if the owner of the map is lost in a forest, a mere topographic map is useless to this person, because the person does not know his or her location on the map. Assuming further that the lost person carries a GPS receiver and the way in which the map is bound to the KKJ coordinate system is indicated in the margin of the person's topographic map, the person is still unable to find out his or her location on the map. Thanks to his or her GPS receiver, the person knows his or her location in the WGS84 coordinate system but does probably not know how to use this knowledge to calculate his or her location in the KKJ coordinate system. Or, even if the person did know that, the calculation would be so complex that it would be difficult to perform it manually, even if the person was carrying a calculator.

With the current methods, it is not possible to provide navigation services for irregular maps, because the scale of an irregular map may vary arbitrarily, and these maps often represent more or less an artist's view of the area. One example of this is the slope map of a downhill skiing centre. It is easy for a downhill skier to navigate on the base of the map from one slope to another, but it is difficult to find out from the map one's actual location. Typically these maps are spread out in such manner that a number of slopes may be visible side by side on the same page, when they are actually distributed evenly throughout the mountain.

### OBJECTIVE OF THE INVENTION

The objective of the invention is to disclose a new type of method for binding an irregular map to a coordinate system. One specific objective of the invention is to alleviate the problems referred to above and allow the production of navigation services also for irregular maps.

### SUMMARY OF THE INVENTION

In this patent application, the term ‘irregular map’ refers to a map that is not bound to a known coordinate system or to a map that is bound to a known coordinate system but for some reason the owner of the map does not know this binding accurately enough in view of the intended use of the map. For example, in the case of slope maps of downhill skiing centres, the accuracy of tens of metres is sufficient.

In this patent application, the idea of the map being bound to a known coordinate system means that there are mappings F and/or I, and that they are substantially known with sufficient accuracy in view of the intended use of the map, such that

F(x0,y0)->(x1,y1) and

I(x1,y1)->(x0,y0)

where (x0,y0) is the location in a known coordinate system and (x1,y1) is the location on a map. In other words, it is known with sufficient accuracy in view of the intended use of the map which point on the map corresponds to the respective point in the coordinate system, and vice versa.

In this patent application, mappings F and I refer to the above-mentioned mappings wherein F is the mapping of the known coordinate system onto the map and I is the mapping of the map into the known coordinate system. Mappings F and I may be approximative.

In this patent application, the term ‘reference point’ refers to individual points on the map for which mappings F and I are known. If there are entire areas or other non-point objects on the map for which mappings F and I are known, these areas are considered as consisting of a set of reference points.

The present invention is particularly useful for providing navigation services for already existing irregular maps, because the irregular map image which is intended to be used is typically already there. For example downhill skiing centres, outdoor areas and public transportation have typically already prepared irregular map images to be used in guide signs or given out as paper guide maps. Providing these images as digital maps which can be used to automatically display for example geographical locations is an efficient and desired solution in terms of expenses. Furthermore, the map images that are already in use may be trademarks of the map provider or a part of their established graphical appearance or brand, in which case their use specifically is desirable also in digital applications. Thanks to the invention, it is easy to start using the existing irregular map images in this novel manner. Furthermore, the invention provides the advantage that if an irregular map image used is being modified, it is easy to update the change into the coordinates because it only requires updating the changed reference points, adding new reference points or deleting the reference points associated with the objects removed from the map.

### LIST OF FIGURES

FIG. 1 illustrates the method according to the invention for determining location of a lost person on a map, and

FIG. 2 illustrates one example for calculating the location in the method according to FIG. 1.

### DETAILED DESCRIPTION OF THE INVENTION

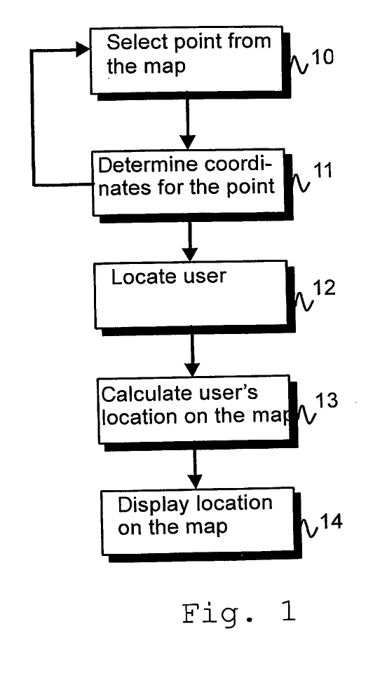

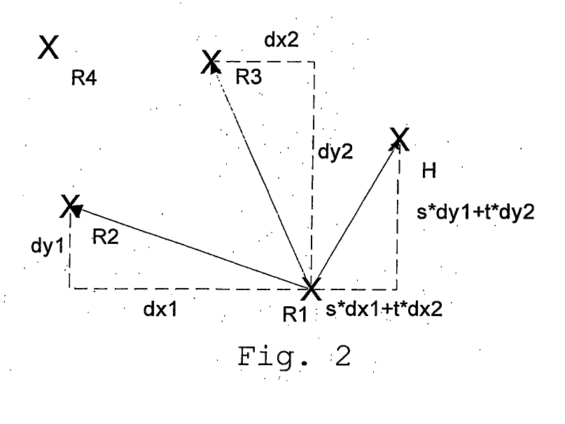

In the following section, the invention will be described in more detail with reference to the accompanying FIGS. 1 and 2 which illustrate the method according to the invention for determining location of a lost person on a map.

The method is based on a set of reference points for which the location is known on the map and in a known coordinate system. In the first step of the method, the reference points are determined by determining for points selected from an irregular map, step 10, coordinates in a known coordinate system, step 11. The reference points are indicated in the drawing of FIG. 2 as R1, R2, R3 and R4. For example, the owner of the map may have acquired the reference points by going to a spot the location of which the person knows on the map, and by noting down the location of this spot in the WGS84 coordinate system. The person is able to find out the location of the reference point in the WGS84 coordinate system for example by using a GPS receiver, other satellite positioning device or other suitable positioning method. A sufficient number of these reference points is determined according to need. Then the end user locates him/herself with the positioning device, for example with the satellite positioning device, step 12. Next, the location of the user on the map is estimated by means of the reference points, step 13. Finally, the location is displayed to the user, step 14. In addition to displaying the location, it can be sent to a navigation software which can guide the user from the present point to a desired point in such manner that the navigation instructions are displayed on the irregular map.

In the following section, one realization of step 13 for locating a user on an irregular map is described. However, this is not the only way according to the method realizing the present invention; instead any deduction based on reference points is suitable.

The location of a person in the WGS84 coordinate system is assumed as (lon0,lat0), and the person's location on map H, which the person is trying to find out, denoted as (x0,y0).

Locations of the reference points in the WGS84 coordinate system are denoted as (lon1,lat1), (lon2,lat2), (lon3,lat3), (lon4,lat4) and on the map as (x1,y1), (x2,y2), (x3,y3), (x4,y4).

Next, those three which are closest to the actual location of the person in the WGS84 coordinate system are picked from the set of reference points. Assume that points R1, R2 and R3 are selected. The person's location on the map can now be calculated as follows:

Denote

dlon1=lon2−lon1;

dlat1=lat2−lat1;

dlon2=lon3−lon1;

dlat2=lat3−lat1;

dx1=x2−x1;

dy1=y2−y1;

dx2=x3−x1;

dy2=y3−y1;

(x,y) are solved in the system of equations

lon0=lon1+s*dlon1+t*dlon2;

lat0=lat1+s*dlat1+t*dlat2;

x0=x1+s*dx1+t*dx2;

y0=y1+s*dy1+t*dy2;

The system of equations has an unambiguous solution (x0,y0) each time the reference points R1, R2 and R3 are not located on the same straight line, so the person may calculate his or her location anywhere over the map area. This corresponds to mapping F.

Correspondingly, if the person does not know his or her location in the WGS84 coordinate system but knows his or her location on the map, the person may, when (x0,y0) are known, solve figures (lon0,lat0) in the above-mentioned system of equations, which corresponds to the inverse mapping I.

The method described above is approximative because it does not take into account for example curvature of the WGS84 coordinate system but instead processes it as a plane. However, if the reference points are close to each other, the approximation error is so small that it is practically insignificant.

In the method described above it is to be noted that if there is a sufficient number of reference points, it can be used for mapping even completely irregular maps and maps on a false scale. Since the three closest points are selected from the reference points, the mapping adapts to the irregularities of the map.

Although three reference points were selected in the example described above, it is possible to select a different number of them as well. For example, it is possible to obtain sufficient accuracy with fewer points if the application does not require strictly accurate positioning, or for example in the case of a route that can be acquired in digital format, for example a nature trail. In this case, the location on the route can be determined by two points which are used for estimating the location on the route between these two points. Since it can be assumed that in normal conditions, there is no departing from the route, the determination may be quite accurate.

One practical application of the method is a map in digital format. In the context of a digital map, methods according to this invention can be applied easily and efficiently, and also more complex methods can be developed within the limits of the computing capacity available in each device.

The method described above can preferably be applied in slope maps of a downhill skiing centre. In downhill skiing centres, the user of the map wants to locate him/herself in terrain which, as depicted by the conventional geographical maps, is uninformative to the user of the map due to differences in altitude and small number of landmarks indicated in general maps. In these situations, the user of the map is more interested in gathering the locations than distances between the landmarks on the map. This is why maps prepared by downhill skiing centres for their customers are typically stylized panoramic views which the customer of the ski slope can use to locate him/herself with respect to landmarks that are characteristic of a downhill skiing centre, such as ski lifts or ski slopes. When this type of irregular map image can be bound to a known coordinate system, such as for example the coordinate system used by a GPS positioning device, the user can be provided with the display of real-time location for example of him/herself or some other object of interest on a stylized irregular slope map.

Furthermore, one preferred embodiment of the invention is to apply the method in other outdoor area maps. For example, maps of hiking trails or large parks are often prepared specifically for visitors, indicating the paths and trails leading from one place to another. There is often no reason to draw this type of map to a scale, because for example trail lengths may differ very much from each other, so that if they were all depicted on the same map drawn to a scale, the objects that are close to each other would be set too close to each other, whereas part of the map image would be wasted around objects located far from the other ones. In this type of map, it is more relevant for example to indicate the length of the hiking trails next to the symbol of the trail on the map. Thanks to the invention, it is possible to depict the location of an object for which the geographical coordinates are known on this type of map.

Similarly, the invention can be utilized in maps depicting transportation vehicle routes, such as for example underground, tram, train or bus routes. These maps are prepared as topological maps where the geographical location of the stations or stops in respect to each other is not so important to the passenger. What is important for the passenger is to known his or her location at the junctions of the topological map and between the routes connecting the junctions. This need is acknowledged by installing displays demonstrating the progress of the journey in public transportation vehicles. However, such displays are not installed in a comprehensive number of transportation vehicles, and often these displays do not adapt to exceptional rerouting or rescheduling events. Furthermore, there are situations where the passenger may want to carry his or her own map intended for this purpose, such as for example a map prepared in the passenger's language or operating in a separate terminal device, such as a mobile telephone. Thanks to the invention, it is easy to prepare such maps even by the passenger him/herself.

The inventive method above is preferably implemented as a software product arranged to execute the functionality according to the invention when executed in a data processing device. Preferably, such device is a portable device, such as a mobile phone, navigating device, PDA device or other similar device capable of executing software products.

The invention is not limited merely to the exemplifying embodiments referred to above; instead, many variations are possible within the scope of the inventive idea defined by the claims.

1. A method for binding an irregular map to a known coordinate system, wherein at least one reference point is determined by selecting the desired point from the irregular map, and the corresponding point in the known coordinate system is determined as well.

2. The method according to claim 1, wherein the location on the irregular map is determined by using said reference points.

3. The method according to claim 2, wherein the location of the point selected from the irregular map is calculated arbitrarily by using the set of reference points.

4. The method according to claim 1, wherein the existing irregular map is bound to a coordinate system.

5. The method according to claim 1, wherein the location of the desired irregular point in the known coordinate system is determined by using satellite positioning.

6. The method according to claim 1, wherein the location of the desired irregular point in the known coordinate system is determined by using a positioning device based on measuring the location in respect to mobile telephone network base stations, wireless network base stations or other radio devices.

7. A software product for binding an irregular map to a known coordinate system, wherein the software product is arranged to execute the method according to claim 1 when the software product is executed in a data processing system.

8. A device for binding an irregular map to a known coordinate system, wherein the device is arranged to execute the method according to claim 1.

9. The device according to claim 8, wherein the device is arranged to execute said method by executing a software product for binding an irregular map to a known coordinate system, wherein the software product is arranged to execute a method for binding an irregular map to a known coordinate system, wherein at least one reference point is determined by selecting the desired point from the irregular map, and the corresponding point in the known coordinate system is determined as well, when the software product is executed in a data processing system.

10. The device according to claim 8, wherein the device is a mobile telephone, a portable computer, a PDA device or a personal navigator.
